(19) United States
(12) Patent Application Publication
(10) Pub. No.: US 2015/0187459 A1
(43) Pub. Date: Jul. 2, 2015

(54) LOW SPECIFIC GRAVITY THERMOPLASTIC COMPOUNDS FOR NEUTRAL BUOYANCY UNDERWATER ARTICLES

(71) Applicant: PolyOne Corporation, Avon Lake, OH (US)

(72) Inventors: Brian Fairchild, Stow, OH (US); Doug Hammond, Downey, CA (US)

(73) Assignee: PolyOne Corporation, Avon Lake, OH (US)

(21) Appl. No.: 14/410,840

(22) PCT Filed: Jun. 28, 2013
(86) PCT No.: PCT/US2013/048505

§ 371 Date: Dec. 23, 2014

Related U.S. Application Data
(60) Provisional application No. 61/667,793, filed on Jul. 3, 2012.

(51) Int. Cl. H01B 3/28; H01B 7/14; H01B 7/28; H01B 3/44

(52) U.S. Cl. CPC H01B 3/28; H01B 3/441; H01B 7/14; H01B 7/2813

(57) ABSTRACT

A thermoplastic compound is disclosed which has low specific gravity by virtue of the use of glass microspheres. Underwater articles, especially wire and cable, benefit from the insulative and buoyancy effect of using the thermoplastic compound with the other article components, engineered using buoyancy calculations to have consistent neutral buoyancy for reduced energy expenditure and convenient maneuverability of the underwater articles as if they were floating in outer space.

### CLAIM OF PRIORITY

This application claims priority from U.S. Provisional Patent Application Ser. No. 61/667,793 bearing Attorney Docket Number 12012006 and filed on Jul. 3, 2012, which is incorporated by reference.

### FIELD OF THE INVENTION

This invention relates to low specific gravity thermoplastic compounds.

### BACKGROUND OF THE INVENTION

The world of polymers has progressed rapidly to transform material science from wood and metals of the 19^{th} Century to the use of thermoset polymers of the mid-20^{th} Century to the use of thermoplastic polymers of later 20^{th} Century. Unlike glass, wood, or metal, thermoplastic polymer compounds do not shatter, decay, or rust.

Polymer compounds have become quite useful for insulation and jacketing of wire and cables containing electrical conductors, glass fibers, etc. In most terrestrial uses, the wire and cable insulation layer or jacketing is more directed to such attributes as flame retardancy, surface lubricity, coloration, etc.

Missing from these attributes is neutral buoyancy, which is vital in underwater wire and cables.

As seen in U.S. Pat. No. 7,234,410 (Quigley et al.); EP Pat No. 0 521 582 (Shell); and EP 1 981 037 (Water Cleaner Ltd.), flowable thermoplastic buoyancy materials can be employed to control buoyancy of a cable during underwater transport or after placement on the seabed. Hollow glass microspheres are mentioned by each as filler for the buoyant material.

### SUMMARY OF THE INVENTION

What the art needs is a thermoplastic compound for wire and cable insulation or jacketing establishing and maintaining a neutral buoyancy during underwater usage. The thermoplastic compounds needs to have a low specific gravity, acceptably any amount less than 0.95 g/cm³ and preferably less than 0.8 g/cm³ in order that the low specific gravity of the wire insulation or jacketing can counterbalance the greater-than-one specific gravity of any other component of the wire or cable, such as copper wire, protective metal cladding, etc.

The present invention solves the problem by formulating a thermoplastic compound that utilizes glass microspheres to reduce specific gravity of that thermoplastic compound within a given mass and volume, in order that its mass at that specific gravity can counterbalance the masses of the other components of the wire or cable at their respective densities, in order to achieve neutral buoyancy for the entire article meant for undersea usage or any designated portion thereof.

One aspect of the invention is a low specific gravity thermoplastic compound, comprising (a) a polyolefin; (b) elastomeric impact modifier; and (c) an efficacious amount of glass microspheres to reduce specific gravity of the compound to less than 0.95 g/cm³. The compound is solid in form and formed into a non-particulate mass associated with at least one other mass having a greater specific gravity than the thermoplastic compound.

Another aspect of the invention is an article constructed from the low specific gravity compound to counterbalance the specific gravity of the remainder article, such that the combined densities match the specific gravity of water where the article is to be used. Particularly, an article can be a wire or cable including a concentric layer of the low specific gravity thermoplastic compound to counterbalance the greater specific gravity of a core of metal or other denser materials.

Features of the invention will become apparent with reference to the following embodiments.

### EMBODIMENTS OF THE INVENTION

### Polyolefin

Polyolefin is frequently used as a thermoplastic matrix.

Non-limiting examples of polyolefins useful as thermoplastic olefins of the invention include homopolymers and copolymers of lower α-olefins such as 1-butene, 1-pentene, 1-hexene, 2-methyl-1-propene, 3-methyl-1-pentene, 4-methyl-1-pentene, and 5-methyl-1-hexene, as well as ethylene, butylene, and propylene, with homopolymers and copolymers of propylene being preferred. Polypropylene and olefinic copolymers of polypropylene (PP) have thermoplastic properties best explained by a recitation of the following mechanical and physical properties: a rigid semi-crystalline polymer with a modulus of about 300 MPa to about 1 GPa, a yield stress of about 5 MPa to about 35 MPa, and an elongation to ranging from about 10% to about 1,000%.

Selection of a polyolefin from commercial producers can use Melt Flow Rate (MFR) properties. The MFR can range from about 0.05 to about 1400, and preferably from about 0.5 to about 70 g/10 min at 230° C. under a 2.16 kg load. For polypropylene, that MFR should be from about 0.5 to about 70 and should be tailored to best suit the shape forming process, such as extrusion or injection molding.

Non-limiting examples of polypropylenes useful for the present invention are those commercially available from suppliers such as Dow Chemicals, Huntsman Chemicals, Formosa, Phillips, ExxonMobil Chemicals, Basell Polyolefins, and BP Amoco.

Elastomeric Impact Modifier

Any suitable elastomer can be used as an elastomeric impact modifier. It is preferred that the elastomer has a substantially saturated hydrocarbon backbone chain that causes the copolymer to be relatively inert to ozone attack and oxidative degradation, but that the elastomer may have side-chain unsaturation available for at least partial crosslinking.

Examples of suitable elastomers include natural rubber, polyisoprene rubber, styrenic copolymer elastomers (i.e., those elastomers derived from styrene and at least one other monomer, elastomers that include styrene-butadiene (SB) rubber, styrene-butadiene-styrene (SBS) rubber, styrene-ethylene-butadiene-styrene (SEBS) rubber, styrene-ethylene-ethylene-styrene (SEES) rubber, styrene-ethylene-propylene-styrene (SEPS) rubber, styrene-isoprene-styrene (SIS) rubber, styrene-isoprene-butadiene-styrene (SIBS) rubber, styrene-ethylene-propylene-styrene (SEPS) rubber, styrene-ethylene-ethylene-propylene-styrene (SEEPS) rubber, styrene propylene-styrene (SPS) rubber, and others, all of which may optionally be hydrogenated), polybutadiene rubber, nitrile rubber, butyl rubber, and olefinic elastomer such as ethylene-propylene-diene rubber (EPDM) and ethylene-octene copolymers are non-limiting examples of useful elastomers according to the invention. Especially preferred are olefinic elastomers, especially EPDM, where the EPDM has been crosslinked partially or fully.

Olefinic elastomers are especially useful as elastomeric impact modifiers in polyolefins because of their reasonable cost for properties desired. Of these elastomers, EPDM is preferred because it is a fundamental building block in polymer science and engineering due to its low cost and high volume, as it is a commodity synthetic rubber since it is based on petrochemical production. EPDM is also preferred because it has one of the lowest glass transition temperatures (T_{g}) available commercially and yet is reasonable in cost in providing that property to a thermoplastic compound.

EPDM encompasses copolymers of ethylene, propylene, and at least one nonconjugated diene. The benefits of using EPDM are best explained by the following mechanical and physical properties: low compression set at elevated temperatures, the ability to be oil extended to a broad range of hardness, and good thermal stability.

Selection of an olefinic elastomer from commercial producers uses Mooney Viscosity properties. The Mooney Viscosity for olefinic elastomer can range from about 1 to about 1,000, and preferably from about 20 to about 150 ML 1+4 @ 100° C. For EPDM, that Mooney Viscosity should be from about 1 to about 200, and preferably from about 20 to 70 ML 1+4 @ 100° C., when the elastomer is extended with oil. Non-limiting examples of EPDM useful for the present invention are those commercially available from multinational companies such as Bayer Polymers, Dow Chemical, Uniroyal Chemicals (now part of Lion Copolymer LLC), ExxonMobil Chemicals, DSM, Kumho, Mitsui, and others.

The elastomer itself can be provided in a variety of forms. For example, elastomers are available in liquid, powder, bale, shredded, or pelletized form. The form in which the elastomer is supplied influences the type of processing equipment and parameters needed to form the thermoplastic compound. Those of ordinary skill in the art are readily familiar with processing elastomers in these various forms and will make the appropriate selections to arrive at the elastomeric impact modifier component of the invention.

Alternatively, one can use a pre-mixed blend of a continuous phase of a polyolefin such as polypropylene and a discontinuous phase of a vulcanized rubber such as crosslinked EPDM. These blends are commercially available as thermoplastic vulcanizate (TPV) concentrates from ExxonMobil Corporation in a number of grades marketed under the Santoprene™ brand, particularly the Santoprene™ 8000 series grades. It was reported by the manufacturer that Santoprene™ 8000 series grades have a halogen content of less than 200 parts per million. Of the Santoprene™ 8000 grades, Santoprene™ RC8001 TPV concentrate is presently preferred. Using Santoprene™ RC8001 TPV concentrate has the advantage that, as a ready-vulcanized concentrate, there is no risk of the other ingredients interfering with the vulcanization system, or of vulcanization chemicals adversely interacting with the other ingredients in the thermoplastic compound.

Glass Microspheres

Glass microspheres are also known as glass microbeads. This product is well known for a variety of purposes.

A useful summary of the status of glass microspheres can be found in United States Patent Application Publication No. US 2007/0012351 (Horemans) and assigned to 3M Company, a sophisticated user of glass microspheres for a variety of films, adhesives, reflective articles, etc. The remainder of this section is an adaptation from Horemans.

Glass microspheres can be any type of hollow or semi-solid spheres. Generally however, hollow glass spheres are used. Useful microspheres are hollow, generally round but need not be perfectly spherical; they may be cratered or ellipsoidal, for example. Even though sometimes irregular in shape, they remain generally referred to as “microspheres”.

Glass microspheres can be generally from about 5 to 100 micrometers in volume average diameter. In a particular embodiment, the microspheres have a volume average diameter between 10 and 50 micrometers. A practical and typical volume average diameter can be from 15 to 40 micrometers. Microspheres comprising different sizes or a range of sizes can be used.

Glass microspheres should have a collapse strength in excess of the anticipated pressures that may arise during the mixing with the molten impact modified thermoplastic compound in processing equipment. Generally, the microsphere should have a burst strength in excess of 4000 psi (27.6 MPa), preferably in excess of 5000 psi (34.5 MPa) as measured by ASTM D3102-78 with 10% collapse and percent of total volume instead of void volume as stated in the test. In a particular embodiment, the glass microspheres can have a burst strength of at least 15,000 psi or even higher such as for example at least 18,000 psi or 30,000 psi.

The specific gravity of hollow glass microspheres for use with this invention can vary from about 0.1 to 0.9 g/cm³, and is typically in the range of 0.2 to 0.7 g/cm³. Preferably, to reduce specific gravity of the impact modified thermoplastic compound, the lower the specific gravity the better so long as the lower specific gravity maintains its collapse strength. Specific gravity is determined (according to ASTM D-2840-69) by weighing a sample of microspheres and determining the volume of the sample with an air comparison pycnometer (such as a AccuPyc 1330 Pycnometer or a Beckman Model 930).

Glass microspheres have been known for many years, as is shown by European Patent 0 091,555, and U.S. Pat. Nos. 2,978,340, 3,030,215, 3,129,086 3,230,064, and U.S. Pat. No. 2,978,340, all of which teach a process of manufacture involving simultaneous fusion of the glass-forming components and expansion of the fused mass. U.S. Pat. No. 3,365,315 (Beck), U.S. Pat. No. 4,279,632 (Howell), U.S. Pat. No. 4,391,646 (Howell) and U.S. Pat. No. 4,767,726 (Marshall) teach an alternate process involving heating a glass composition containing an inorganic gas forming agent, and heating the glass to a temperature sufficient to liberate the gas and at which the glass has viscosity of less than about 104 poise.

Size of hollow glass microspheres can be controlled by the amount of sulfur-oxygen compounds in the particles, the length of time that the particles are heated, and by other means known in the art. The microspheres may be prepared on apparatus well known in the microspheres forming art, e.g., apparatus similar to that described in U.S. Pat. Nos. 3,230,064 or 3,129,086.

One method of preparing glass microspheres is taught in U.S. Pat. No. 3,030,215, which describes the inclusion of a blowing agent in an unfused raw batch of glass-forming oxides. Subsequent heating of the mixture simultaneously fuses the oxides to form glass and triggers the blowing agent to cause expansion. U.S. Pat. No. 3,365,315 describes an improved method of forming glass microspheres in which pre-formed amorphous glass particles are subsequently reheated and converted into glass microspheres. U.S. Pat. No. 4,391,646 discloses that incorporating 1-30 weight percent of B₂O₃, or boron trioxide, in glasses used to form microspheres, as in U.S. Pat. No. 3,365,315, improves strength, fluid properties, and moisture stability. A small amount of sodium borate remains on the surface of these micro spheres, causing no problem in most applications. Removal of the sodium borate by washing is possible, but at a significant added expense; even where washing is carried out, however, additional sodium borate leaches out over a period of time.

Hollow glass microspheres are preferably prepared as described in U.S. Pat. No. 4,767,726. These microspheres are made from a borosilicate glass and have a chemical composition consisting essentially of SiO₂, CaO, Na₂O, B₂O₃, and SO₃ blowing agent. A characterizing feature of hollow microspheres resides in the alkaline metal earth oxide:alkali metal oxide (RO:R₂O) ratio, which substantially exceeds 1:1 and lies above the ratio present in any previously utilized simple borosilicate glass compositions. As the RO:R₂O ratio increases above 1:1, simple borosilicate compositions become increasingly unstable, devitrifying during traditional working and cooling cycles, so that “glass” compositions are not possible unless stabilizing agents such as Al₂O₃ are included in the composition. Such unstable compositions have been found to be highly desirable for making glass microspheres, rapid cooling of the molten gases by water quenching, to form frit, preventing devitrification. During subsequent bubble forming, as taught in aforementioned U.S. Pat. Nos. 3,365,315 and 4,391,646, the microspheres cool so rapidly that devitrification is prevented, despite the fact that the RO:R₂O ratio increases even further because of loss of the relatively more volatile alkali metal oxide compound during forming.

Suitable glass microspheres that can be used in connection with the present invention include those commercially available such as iM30K Glass Spheres from 3M Company of St. Paul, Minn., USA orHGMS—0.14 and 0.46 glass spheres from Cospheric, LLC of Santa Barbara, Calif., USA. Glass microspheres for purposes of this invention can have a bulk density from about 0.07 to about 0.5 and preferably from about 0.3 to about 0.5 g/cm³; an effective (true) density of from about 0.12 to about 0.70 and preferably from about 0.14 to about 0.60 g/cm³; a mean particle size of from about 15 to about 60 and preferably from about 16 to about 30 μm; a particle size range of from about 15 to about 120 and preferably from about 3 to about 33 μm; and a maximum working pressure of from about 3.44 MPa (500 psi) to about 206.8 MPa (30,000 psi) and preferably from about 103.4 MPa (15.000 psi) to about 193 MPa (28,000 psi). Presently preferred is the iM30K Glass Spheres, which have a bulk density of 0.37 g/cm³, an effective density of 0.6 g/cm³, a mean particle size of 16 μm, a particle size range of 8-35 μm, and a maximum working pressure of 30,000 psi (206.8 MPa). The pressures of transport and usage in underwater and seabed conditions require the microspheres to maintain their structure and not collapse or break.

Optional Additives

The compound of the present invention can include conventional plastics additives in an amount that is sufficient to obtain a desired processing or performance property for the compound. The amount should not be wasteful of the additive or detrimental to the processing or performance of the compound. Those skilled in the art of thermoplastics compounding, without undue experimentation but with reference to such treatises as Plastics Additives Database (2004) from William Andrew Applied Science Publishers (www.elsevier.com), can select from many different types of additives for inclusion into the compounds of the present invention.

Non-limiting examples of optional additives include adhesion promoters; biocides (antibacterials, fungicides, and mildewcides), anti-fogging agents; anti-static agents; bonding, blowing and foaming agents; dispersants; fillers and extenders; smoke suppresants; impact modifiers; initiators; lubricants; micas; pigments, colorants and dyes; plasticizers; processing aids; other polymers; release agents; silanes, titanates and zirconates; slip and anti-blocking agents; stabilizers; stearates; ultraviolet light absorbers; viscosity regulators; waxes; and combinations of them.

Any conventional plasticizer, preferably a paraffinic oil, is suitable for use the present invention. The amount of plasticizer oil, if present, significantly influences the hardness of the thermoplastic compound of the invention, such that the Shore Hardness as measured using ASTM D2240 (10 seconds) can range from about 20 Shore OO to about 45 Shore D and preferably from about 40 to about 90 Shore A.

If plasticizer oil is present, the ratio of plasticizer oil to elastomeric impact modifier can range from about 0.67:1 to about 2:1 and preferably from about 0.75:1 to about 1:1.

Table 1 shows acceptable, desirable, and preferable ranges of ingredients useful in the present invention, all expressed in weight percent (wt. %) of the entire compound. The compound can comprise, consist essentially of, or consist of these ingredients.

TABLE 1
Ranges of Ingredients

| Ingredient | | | |
|---|---|---|---|
| (Wt. Percent) | Acceptable | Desirable | Preferable |
| Polyolefin | 6%-30% | 10%-25% | 15-20% |
| Elastomeric | 5%-40% | 15%-35% | 25%-30% |
| Impact Modifier | | | |
| Glass | 10%-50% | 20%-40% | 25%-30% |
| Microspheres | | | |
| Plasticizer | 0-40% | 10%-30% | 20%-27% |
| Lubricant | 0-2% | 0.1-1.5% | 0.1-1% |
| Processing | 0-1% | 0.1-1% | 0.1-1% |
| Stabilizer | | | |
| Other Optional | 0-4% | 0-2% | 0-1% |
| Additives | | | |

Processing

The preparation of compounds of the present invention is uncomplicated once the proper ingredients have been selected. The compound of the present can be made in batch or continuous operations.

Mixing in a continuous process typically occurs in an extruder that is elevated to a temperature that is sufficient to melt the polymer matrix with addition of all additives at the feed-throat, or by injection or side-feeders downstream. The glass microspheres are added typically by side-feeders alone or mixed with other additives. Plasticizer oil can be added after the addition of the glass microspheres. Extruder speeds can range from about 50 to about 500 revolutions per minute (rpm), and preferably from about 200 to about 400 rpm. Typically, the output from the extruder is pelletized for later extrusion or molding into polymeric articles.

Mixing in a batch process typically occurs in a Banbury mixer that is also elevated to a temperature that is sufficient to melt the polymer matrix to permit homogenization of the compound components. The mixing speeds range from 60 to 2000 rpm. Also, the output from the mixer is chopped into smaller sizes for later extrusion or molding into polymeric articles.

Subsequent extrusion or molding techniques are well known to those skilled in the art of thermoplastics polymer engineering. Without undue experimentation but with such references as “Extrusion, The Definitive Processing Guide and Handbook”; “Handbook of Molded Part Shrinkage and Warpage”; “Specialized Molding Techniques”; “Rotational Molding Technology”; and “Handbook of Mold, Tool and Die Repair Welding”, all published by Plastics Design Library (www.elsevier.com), one can make articles of any conceivable shape and appearance using compounds of the present invention.

### Usefulness of the Invention

The low specific gravity thermoplastic compound bears all of the attributes for use as insulation or jacketing for wire and cable, but adds via the glass microspheres the ability to tailor specific gravity of the material in order that other components of the wire or cable can be assessed as to their specific gravity and mass so as to provide a consistently neutrally buoyant wire or cable.

Typically a wire or cable, as seen at its end or via a transverse or radial cut, has at least two layers, preferably concentric: (a) a core or inner layer of wire or glass fiber or other valuable material which is communicating energy or information through the wire or cable and (b) a protective layer protecting that core and its valuable materials and operational use from the environment in which the wire or cable is being used. The thermoplastic compound can be used as the protective layer in this two-layer structure.

Often, a third layer can reside outwardly from the protective layer mentioned above, with the third layer providing a different type of protection to the core and the protective layer. In some instances, the protective layer is electrically or thermally or shock insulating, whereas the third layer is jacketing the protective layer and the core from the harsh environment. Hence, the protective or middle layer in this construction can be called an insulating layer, and the outermost layer can be called a jacketing layer.

Regardless of the construction, without undue experimentation or calculation, one having ordinary skill in the art can use the thermoplastic compound at any given low specific gravity to construct a wire or cable having at any segmented distance a consistently neutral buoyancy for use in underwater environments where tremendous pressure, darkness, and cold are the norm.

If the specific gravity of the protective layer, less dense than water, were to counterbalance the specific gravity of the core, more dense than water, then an equilibrium would be achieved at the point where the combined specific gravity of the combination of the core and protective layers matched or equaled the specific gravity of that water.

Density of seawater is different than density of fresh water, itself the basis of determination of specific gravity. Within both seawater and fresh water, there can be subtle but significant variations in the specific gravity of the water in which the underwater wire or cable or other article is to be used. For example, the specific gravity in an estuary of brackish water can be neither that of fresh water or seawater. Also, the with the salinity differences between the Gulf Stream flowing in the Atlantic Ocean and the still and very salty saltwater of the Dead Sea in Israel, very different specific gravities of these different types of saltwater must be consistent to achieve the goal of consistent neutral buoyancy in the body of water in which the underwater article is to be used.

Therefore, it is important in planning the amounts of each component in the underwater article to account for their respective specific gravities in order to design that underwater article to have consistent neutral buoyancy which allows the underwater article to figuratively float as if in a zero gravity environment, greatly reducing the amount energy to place or maintain in place or move into place the underwater article in its location underwater.

A variety of calculations can be used to achieve the combined specific gravity of the entire article to be matched with the specific gravity of the water in which the article will be used. Below are two examples of how equations can be used to determine the proper mass of thermoplastic compound of the invention or to determine the proper volume or area per unit distance that the thermoplastic compound should occupy, all to achieve consistent, unvarying neutral buoyancy.

At a simplified level, the establishment of neutral buoyancy utilizes the algorithm of Equation 1:

$$\frac{Core Mass + Protective Layer Mass}{Core Volume + Protective Layer Volume} = Water Specific gravity$$

With volumes unknown but densities of the core and the protective layer known, Equation 2 computes the equivalency of the wire or cable to the water specific gravity.

$$Water Specific Gravity = \frac{Core Mass + Protective Layer Mass}{\frac{Core Mass}{Core Specific gravity} + \frac{Protective Layer Mass}{Protective Layer Specific Gravity}}$$

With the mass of the core layer and the densities of the core, the protective layer, and water all known, the mass of the protective layer can be solved using Equation 3:

$$Protective Layer Mass = \frac{( \begin{matrix}Water Specific Gravity * \\ ( Core Mass / Core Specific Gravity ) ) - Core Mass\end{matrix} )}{( \begin{matrix}1 - \\ ( Water Specific Gravity / Protective Layer Specific Gravity )\end{matrix} )}$$

Already knowing the mass and specific gravity of the core and having solved for the mass of the protective layer, it is then possible to calculate volumes of the core and the protective layer and their respective areas in a wire or cable, with the area of the core being surrounded by the area of the protective layer. In a wire or cable of circular cross-section, the area of the core is circular, surrounded by an annulus of protective layer. If the depth of the wire or cable is assumed to be one unit of the dimension of the specific gravity and volume value, then one can calculate the radius (r) of core and the radius (R) of the wire or cable using Euclidean geometry.

For example, knowing the specific gravity of the thermoplastic compound of the invention being 0.7 g/cm³; the specific gravity of water being 1.0 g/cm³; and the specific gravity of a metallic core being 2.5, if the metallic core needs a mass of 10 grams, then solving for the mass of the protective layer yields 14 grams for a total of 24 grams. The calculations of the volumes yield 24 cm³ total volume, split into a volume of 4 cm³ for the core and 20 cm³ for the protective layer. The 24 grams divided by the 24 cm³ yields the water specific gravity for the entire wire and cable for that unit distance and a consistent neutral buoyancy for the wire and cable.

Continuing further, the use of the Euclidean geometric equation of πR² for a volume of one cm unit distance permits computation of a total radius (R) of the wire and cable of 8.68 cm and a core radius (r) of 3.54 cm. The protective layer occupies an annulus per unit distance beginning at 3.54 cm and extending to 8.68 cm.

Having knowledge of the practical limit for densities of core materials and the thermoplastic compound of the invention serving as the protective layer permits calculation using electronic spreadsheet relying on the Equation 3 above and the Euclidean geometry above.

For example, at a possible extreme of a core specific gravity of 3 g/cm³; a protective layer specific gravity of 0.6 g/cm³; a water specific gravity of 1.2 g/cm³; and a core mass of 12 grams, solving for the protective layer mass required to achieve a consistent neutral buoyancy yields a mass of 7.2 grams and core volume of 4 cm³; a protective layer volume (annular if a circular cross section) of 20 cm³; a core radius of 3.54 cm; and a total radius of 7.089 cm.

Adjusting for the salinity of water and other factors, with a target specific gravity of the surrounding water already known, then the person having ordinary skill in the art could determine the annulus of protective layer cross-sectional area needed around a core of metal at any given radius, applying Euclidean geometry, as shown above.

Alternatively to the calculations explained above, one could start with the radius of the core needed for the wire or cable for electrical communication, fiber optic communication, or other intended use. Then, with knowledge of the specific gravity of the core, the water specific gravity, and the specific gravity of the thermoplastic compound, one can compute the mass of the core, then the mass of the protective layer, and finally the volumes, which yields the total radius of the wire and cable and the dimensions of the annulus of the protective layer around the planned and known core radius.

Consistent neutral buoyancy is important for underwater articles which are intended for regular mobility or static usage at a location other than the land beneath the water. Unlike a flooded flowline, transported with buoyancy to a drill rig or other location before being immobilized with negative buoyancy for stationary use on the seabed, the undersea surface exploration and utility vehicles strive to maximize as close to neutral buoyancy as consistently as possible.

Because the wire and cable uses thermoplastic compound of solid, non-particulate form surrounding the core, the establishment of that targeted buoyancy is significant, for it can not be altered after the wire or cable is constructed. In other words, the thermoplastic compound is solid, not particulate in form. The protective layer is integral in three dimensions of the annulus into which it is formed. Stated alternatively, the protective layer has a dimensional size of at least one cm, desirably 5 cm, and preferably 10 cm, in at least one dimension, meaning that whether a layer or a cube, the thermoplastic compound is not a particulate of millimeter scale in any dimension. In the case of a protective layer which is an annulus about a core, the length of the protective layer will be on the order of meters, not centimeters. This protective layer of meters in length is non-particulate even though the thickness of the annulus may be less than one cm. Likewise, for other structures of protective layers, so long as any one dimension is at least one cm in distance, both of the other two dimensions can be less than one cm in distance.

Specific gravity of water can vary. It is possible to construct wire or cable of consistent neutral buoyancy for use within strata of such water densities. Alternatively, it is possible to have wire or cable of different but consistent buoyancies at various segments of the wire or cable used within such different strata.

By knowledge of the three densities and mass of the core per unit distance, a person having ordinary skill in the art can compute and compound a thermoplastic protective layer around that core with tailored annular dimension to achieve consistent neutral buoyancy for the wire or cable.

The concept of the consistent neutral buoyancy need not be limited to communication wire or cable or other lifelines in the undersea environment. Conceivably, any article intended for use in a given underwater location could be engineered to have consistent neutral buoyancy for that location. If one presumes for the equations above that the core represents all components of the article collectively other than the thermoplastic compound of the invention, the use of an impact modified polyolefin containing hollow glass microspheres could be used to provide consistent neutral buoyancy for any article destined for use underwater. Non-limiting examples of such articles included cameras, communication structures, nets of all types, barriers of all types, exploratory water craft, utility and repair equipment, storage facilities, storage drums, barrels, SCUBA equipment of all types, hand tools, shark cages, sonar devices, etc. All of these articles can benefit from a thermoplastic compound capable of being engineered into consistent neutral buoyancy jacket or other component in a device or article requiring consistent neutral buoyancy.

The consistent neutral buoyancy goal is not unlike the operation of persons and equipment in zero or low gravity environments. In such conditions whether in outer space or under the surface of the sea, the benefits of Newtonian physics allows for limited energy consumption during operations in such extreme environments, if one co-ops the specific gravity of water and employs the principles of buoyancy.

### EXAMPLES

Table 2 shows two Examples of the present invention, their formulations, sources of ingredients, processing conditions, and resulting properties.

TABLE 2

| | Example 1 | Example 2 |
|---|---|---|
| Ingredient Name (Wt. %) | | |
| NORDEL IP 4770P EPDM | 25 | 29.5 |
| (Dow Chemical) | | |
| Polypropylene -- Melt Flow | 18.9 | 20 |
| Index = 12 | | |
| HYDROBRITE 550 PO | 25.6 | 20 |
| Mineral Oil (Sonneborn) | | |
| 3M iM30K Hollow Glass | 30 | 30 |
| Microspheres (3M) | | |
| LOXIOL G-71S @MDRM | 0.1 | 0.1 |
| 100-499LB Montan Wax | | |
| (BASF) | | |
| KEMAMIDE E ULTRA EBS | 0.1 | 0.1 |
| Unsaturated fatty monoamide | | |
| Wax (Chemtura) | | |
| Irganox 1010 Antioxidant | 0.1 | 0.1 |
| Stabilizer (BASF) | | |
| ULTRANOX 626 Antioxidant | 0.2 | 0.2 |
| Stabilizer (BASF) | | |
| Total | 100 | 100 |

Processing Conditions

| | | |
|---|---|---|
| Extruder | 25 mm twin | 25 mm twin |
| | screw | screw |
| Set Mixing Temps. | 450° F. in Zone | 450° F. in Zone |
| | 1; 440° F. in | 1; 440° F. in |
| | Zone 2; 430° F. | Zone 2; 430° F. |
| | in Zone 3; 420° | in Zone 3; 420° |
| | F. in Zones 4-8 | F. in Zones 4-8 |
| | and the Die | and the Die |
| Percent Torque | 16 | 24 |
| Die Pressure (psi) | 1220 | 710 |
| Melt Temperature | 413° F. | 420° F. |
| Mixing Speed | 300 RPM | 300 RPM |
| Feeder Rate - Throat (lbs/hr) | 11.25 | 12.5 |
| Feeder Rate - Zone 3 (lbs/hr) | 7.5 | 7.5 |
| Feeder Rate - Zone 4 (lbs/hr) | 6.25 | 5 |
| Vented | Zone 5 | Zone 5 |
| Vacuum (inches) | 17 | 17 |
| Order of Addition of | Side Feed of | Side Feed of |
| Ingredients | Hollow Glass | Hollow Glass |
| | spheres at Zone | spheres at Zone |
| | 3; Side Feed of | 3; Side Feed of |
| | Plasticizer Oil at | Plasticizer Oil at |
| | Zone 4 | Zone 4 |
| Form of Product After Mixing | Pellet | Pellet |
| Form of Product For Testing | Molded Plaques | Molded Plaques |
| | of Shape as per | of Shape as per |
| | ASTM tests | ASTM tests |
| | below | below |

Test Results

| | | |
|---|---|---|
| Specific Gravity (ASTM 792) | 0.7213 | 0.7883 |
| Hardness Shore A Inst./10 sec | 91.5/85.7 | 92.5/88 |
| delay (ASTM 2240) | | |
| Hardness Shore D Inst./10 sec | 23.7/19 | 32/23.5 |
| delay (ASTM 2240) | | |
| Tear Resistance (pli) (ASTM | 137 | 159.8 |
| 624) | | |
| Ultimate Tensile Strength 2 | 536 | 672.3 |
| in/min. (psi) (ASTM 412) | | |
| Tensile Elongation (%) at | 344 | 548 |
| Break 2 in/min. (ASTM 412) | | |

Both Examples showed good physical properties for use as a wire or cable insulation or jacket and also had a specific gravity of less than 0.8 g/cm³. Based on the starting point of knowing the mass of the core or the radius of the core to be protected and the densities of the core, the water, the density of the thermoplastic compound of the present invention can be used according to the Equations above to calculate the mass of the thermoplastic compound to be used per unit distance and the area of the annulus of that protective layer so formed about the core per unit distance.

The invention is not limited to the above embodiments. The claims follow.

What is claimed is:

1. A low specific gravity thermoplastic compound, comprising:
(a) a polyolefin;
(b) elastomeric impact modifier; and
(c) an efficacious amount of glass microspheres to reduce specific gravity of the compound to less than 0.95 g/cm³, wherein the compound is in the form of a non-particulate solid having a mass for association with at least one other mass having a greater specific gravity than the thermoplastic compound.

2. The compound of claim 1, wherein the specific gravity is less than 0.8 g/cm³.

3. The compound of claim 1, wherein
the non-particulate solid mass is in the form of an insulation annulus about a core of metal or glass fiber, which results in an article, and wherein the non-particulate solid mass is not a particulate of millimeter scale in any dimension.

4. The compound of claim 3, wherein the core has a specific gravity larger than the specific gravity of the insulation annulus and wherein the combination of the core and the insulation annulus have a combined specific gravity equal to specific gravity of water where the article will be used.

5. The compound of claim 4, wherein the article is a wire or cable having, per unit distance, a combined specific gravity equal to the specific gravity of water in which the wire or cable will be used.

6. The compound of claim 5, wherein, when used underwater, the combined specific gravity of the wire or cable has a consistent neutral buoyancy in the water in which the wire or cable is being used.

7. The compound of claim 6, wherein the wire or cable has at least one segment of distance with a first combined specific gravity and at least one other segment of distance with a second combined specific gravity different from the first combined specific gravity.

8. The compound of claim 7, wherein each segment of distance is configured for use in a location of water having a specific gravity the same or similar to the combined specific gravity of that segment of wire or cable to be used in the location of water.

9. The compound of claim 8, wherein the water is seawater with different amounts of salinity and different specific gravities.

10. The compound of claim 1, wherein the polyolefin is polypropylene, wherein the elastomeric impact modifier is ethylene-propylene-diene rubber, and wherein the compound further comprises plasticizer.

11. The compound of claim 1, wherein the glass microspheres have a volume average diameter of between about 5 and about 100 micrometers, wherein the glass microspheres have a collapse strength in excess of anticipated pressures that may arise during use of the compound underwater, and have a specific gravity of between about 0.1 and about 0.9 g/cm³.

12. The compound of claim 1, further optionally comprising adhesion promoters; biocides; anti-fogging agents; anti-static agents; bonding, blowing and foaming agents; dispersants; fillers and extenders; fire and flame retardants and smoke suppressants; impact modifiers; initiators; lubricants; micas; pigments, colorants and dyes; plasticizers; additional processing aids; release agents; silanes, titanates and zirconates; slip and anti-blocking agents; stabilizers; stearates; ultraviolet light absorbers; viscosity regulators; waxes; and combinations of them.

13. The compound of claim 12, wherein the weight percents of the ingredients comprise:

| | |
|---|---|
| Polyolefin | 6%-30% |
| Elastomeric Impact Modifier | 5%-40% |
| Glass Microspheres | 10%-50% |
| Plasticizer | 0-40% |
| Lubricant | 0-2% |
| Processing Stabilizer | 0-1% |
| Other Optional Additives | 0-4% |

14. An article for use under water under conditions of consistent neutral buoyancy, comprising the thermoplastic compound of claim 1, wherein the thermoplastic compound has a specific gravity to counterbalance specific gravity of a sole other component of the article or all other components of the article.

15. The article of claim 14, wherein the article is molded.

16. The article of claim 14, wherein the article is extruded.

17. The article of claim 14, wherein the other component is metal or glass.

18. The article of claim 17, wherein the article has a combined specific gravity matching the specific gravity of the water.

19. The article of claim 18, wherein the water is fresh water, brackish water, or saltwater.
